(19) United States
(12) Patent Application Publication
(10) Pub. No.: US 2014/0379354 A1
(43) Pub. Date: Dec. 25, 2014

(54) METHOD, APPARATUS AND SYSTEM FOR PAYMENT VALIDATION

(71) Applicant: Tencent Technology (Shenzhen) Co., Ltd., Shenzhen (CN)

(72) Inventors: Xiang Zhang, Shenzhen (CN); Li Lu, Shenzhen (CN); Eryu Wang, Shenzhen (CN); Shuai Yue, Shenzhen (CN); Feng Rao, Shenzhen (CN); Haibo Liu, Shenzhen (CN); Bo Chen, Shenzhen (CN)

(73) Assignee: Tencent Technology (Shenzhen) Co., Ltd., Shenzhen (CN)

(21) Appl. No.: 14/094,228

(22) Filed: Dec. 2, 2013

Related U.S. Application Data
(63) Continuation of application No. PCT/CN2013/084593, filed on Sep. 29, 2013.

(30) Foreign Application Priority Data
Jun. 20, 2013 (CN) 2013102456207

(51) Int. Cl. G06Q 20/40; G10L 21/06

(52) U.S. Cl. CPC G06Q 20/40145; G10L 21/06
USPC 704/275

(57) ABSTRACT

A method, apparatus and system for payment validation have been disclosed. The method includes: receiving a payment validation request from a terminal, wherein the payment validation request includes identification information and a current voice signal; detecting whether the identification information is identical to a pre-stored identification information; if identical: extracting voice characteristics associated with an identity information and a text password from the current voice signal; matching the current voice characteristics to a pre-stored speaker model; if successfully matched: sending an validation reply message to the terminal to indicate that payment request has been authorized. The validation reply message is utilized by the terminal to proceed with a payment transaction. The identity information identifies an owner's current voice signal, and the text password is indicated by the current voice signal. The method eliminates the requirement of the server sending a SMS message with a validation code to the terminal.

### CROSS-REFERENCE TO RELATED APPLICATIONS

This application is a continuation of PCT Application No. PCT/CN2013/084593, filed on Sep. 29, 2013, which claims priority to Chinese Patent Application No. 2013102456207, filed on Jun. 20, 2013, both of which are hereby incorporated by reference in their entireties.

### FIELD OF THE TECHNOLOGY

The present disclosure relates to the field of computer technology and, more particularly, to a method, apparatus and system for payment validation.

### BACKGROUND

Along with the development of Internet technologies, online shopping via computers, smart phones or other terminals has become an essential part of our daily life, and this offers enormous convenience for our life. As online shopping involves users' sensitive personal information, personal identity validation is therefore required when making a payment for online transaction.

Existing on-line payment validation method may include: binding user's account number to a mobile phone number (i.e., a mobile terminal); which the user may input his account number when making an online payment; a server may transmit a short text message, such as a SMS validation message containing a validation code to the user's mobile terminal to which the account number is bound. The user may input the validation code at the mobile terminal, which the terminal may transmit the account number and the validation code to the server; the server detects whether both the account number and the validation code received are correct. If both the account number and the validation code received are correct, the server may then confirm that payment validation is successful, and may allow the mobile terminal to perform a payment transaction. This method has significantly enhanced the security of online payment.

In the process of making the present disclosure, the inventor has discovered that the prior art method still has the following problems: in each payment operation process, the server is required to generate and transmit an SMS validation message containing a validation code, and this generation and sending step still result in an increase of operating cost to the payment service provider.

### SUMMARY

To overcome the prior art payment operation problem which requires the server to transmit an SMS validation message to the user's terminal, which may result in an increased in operating cost, the present disclosure provides a method, apparatus and system for payment validation. The technical scheme is as follows:

In a first aspect, the present disclosure provides a method for payment validation used on a server, the method including:

receiving a payment authentication request from a terminal, wherein the payment authentication request comprises identification information and a current voice signal;

detecting whether the identification information is identical to a pre-stored identification information; if identical:
extracting voice characteristics (such as speech sp) associated with an identity information and a text password from the current voice signal;
matching the current voice characteristics to a pre-stored speaker model; if successfully matched:
   sending an authentication reply message to the terminal to indicate that payment request has been authorized, wherein the authentication reply message is utilized by the terminal to proceed with a payment transaction, wherein the identity information identifies an owner of the current voice signal, and the text password is a password indicated by the current voice signal.

In a second aspect, the present disclosure provides a method for processing payment validation request sent through a microphone of a terminal, including a server, performing:

receiving from the terminal, identification information input by a user;

acquiring current voice signal collected by the terminal microphone;

transmitting a payment validation request from the terminal to the server, wherein the payment validation request comprises identification information and the current voice signal, such that the server performs validation on the payment validation request;

detecting whether the identification information is identical to a pre-stored identification information; if identical:
extracting voice characteristics associated with an identity information and a text password from the current voice signal;
matching the current voice characteristics to a pre-stored speaker model; if successfully matched:
   sending by the server, an validation reply message to the terminal to indicate that payment request has been authorized, wherein the validation reply message is utilized by the terminal to proceed with a payment transaction, wherein the identity information identifies an owner of the current voice signal, and the text password is a password indicated by the current voice signal.

In a third aspect, the present disclosure provides an apparatus for processing a payment validation request on a server, comprises at least a processor operating in conjunction with a memory and a plurality of modules, the plurality of modules which include:

an validation request reception module for receiving a payment validation request sent from a terminal, the payment validation request comprises identification information and a current voice signal;

a first detection module for detecting whether the identification information is identical to a pre-stored identification information;

a first extraction module for extracting voice characteristics associated with an identity information and a text password from the current voice signal; when it is detected that the identification information is identical to the pre-stored identification information;

a matching module for matching the current voice characteristics to a pre-stored speaker model; if successfully matched;

an validation reply transmission module for transmitting an validation reply message to the terminal to indicate that payment request has been authorized for payment transaction, when it is determined that the current voice characteristics has been successfully matched to a pre-stored speaker model, such that the terminal utilizes the received validation reply message to proceed with a payment transaction,

wherein the identity information identifies an owner of the current voice signal, and the text password is a password indicated by the current voice signal.

In a fourth aspect, the present disclosure provides an apparatus for processing payment validation request within a terminal utilizing a microphone, comprises at least a processor operating in conjunction with a memory and a plurality of modules, the plurality of modules include:

a first reception module for receiving identification information input by a user;

a first acquisition module for acquiring current voice signal collected from the microphone;

a validation request transmission module for transmitting a payment validation request to a server, the payment validation request containing the identification information received by the first reception module and the current voice signal acquired by the first acquisition module, such that the server receiving the payment validation request from the terminal performs:
detecting whether the identification information is identical to the pre-stored identification information; if it is detected to be identical:
extracting voice characteristics associated with an identity information and a text password from the current voice signal;
matching the current voice characteristics to a pre-stored speaker model; if successfully matched:
an validation reply transmission module for transmitting an validation reply message to the terminal to indicate that payment request has been authorized for payment transaction, such that the terminal;
an validation reply reception module in the apparatus for receiving the validation reply message transmitted from the server, and utilizing the received validation reply message to proceed with a payment transaction.

In a fifth aspect, the present disclosure provides a system for payment validation, which includes at least a terminal and a server, the terminal and the server being connected through a wired network connection or a wireless network connection,

wherein the terminal utilizes a microphone, comprises at least a processor operating in conjunction with a memory and a plurality of modules, the plurality of modules which include:

a first reception module for receiving identification information input by a user;

a first acquisition module for acquiring current voice signal collected from the microphone;

a validation request transmission module for transmitting a payment validation request to the server, the payment validation request containing the identification information received by the first reception module and the current voice signal acquired by the first acquisition module, such that the server receiving the payment validation request from the terminal performs:
detecting whether the identification information is identical to the pre-stored identification information; if it is detected to be identical:
   extracting voice characteristics associated with an identity information and a text password from the current voice signal;
   matching the current voice characteristics to a pre-stored speaker model; if successfully matched:
      an validation reply transmission module for transmitting an validation reply message to the terminal to indicate that payment request has been authorized for payment transaction;

a validation reply reception module in the apparatus for receiving the validation reply message transmitted from the server, and utilizing the received validation reply message to proceed with a payment transaction;

wherein the server includes:

at least a processor operating in conjunction with a memory and a plurality of modules, the plurality of modules include:

an validation request reception module for receiving a payment validation request sent from a terminal, the payment validation request comprises identification information and a current voice signal;

a first detection module for detecting whether the identification information is identical to a pre-stored identification information;

a first extraction module for extracting voice characteristics associated with an identity information and a text password from the current voice signal; when it is detected that the identification information is identical to the pre-stored identification information;

a matching module for matching the current voice characteristics to a pre-stored speaker model; if successfully matched;
an validation reply transmission module for transmitting an validation reply message to the terminal to indicate that payment request has been authorized for payment transaction, when it is determined that the current voice characteristics has been successfully matched to a pre-stored speaker model, such that the terminal utilizes the received validation reply message to proceed with a payment transaction,

wherein the identity information identifies an owner of the current voice signal, and the text password is a password indicated by the current voice signal.

By receiving a pending payment validation request transmitted from a terminal using voice signal, the server may extract the current voice characteristics associated with the user's identity information and also a user's text password in the current voice signal, after the server has successfully verified the user's identification information in the payment validation request being identical to the pre-stored identification information. After the server has successfully matched the current voice characteristics with the pre-stored speaker model, the server may send a validation reply message back to the user's mobile terminal, and enable the user to proceed with a payment transaction without further entering a SMS validation code generated by the server, which adds several more steps of operation to complete the payment transaction process.

In effect, the voice characteristics matching process has helped to eliminate the server's generation of a SMS validation code, and entering of the SMS code by the user for further verification and for security measure, since the user's voice characteristics is unique only to the user, and would be hard to duplicate or synthesize without performing sophisticated analysis and simulation to mimic similar characteristics. In addition, additional security information such as a password or a PIN (Personal Identity Number) may also be spoken through the voice signal as part of the validation requirements, thus providing more security information to safeguard the validation procedure, yet resolving the added operating cost and delay problems incurred by the prior art payment validation and payment transaction processes.

Therefore, the present disclosure of using voice signal in the payment validation and payment transaction have greatly enhanced the speed of operation, improved security measures, and improves user experiences in the payment validation and payment transaction processes, while significantly reducing operating cost incurred by the generation and entering of SMS validation codes and messages.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 is an exemplary system diagram illustrating an environment of implementing an embodiment of the present disclosure.

FIG. 2 is an exemplary process flow diagram illustrating a method for carrying out a payment validation request, according to an embodiment of the present disclosure.

FIG. 3 is an exemplary process flow diagram illustrating a method for carrying out a payment validation request, according to another embodiment of the present disclosure.

FIG. 4 is an exemplary system block diagram illustrating a system for carrying out a payment validation according to an embodiment of the present disclosure.

FIG. 5 is an exemplary system block diagram illustrating a system for carrying out a payment validation according to another embodiment of the present disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure.

In order to make clearer the objective, technical solution and advantages of the present disclosure, the present disclosure will be further described in detail in combination with the attached drawings and embodiments. It should be understandable that the embodiments are only used to interpret but not to limit the present disclosure. The technical solution of the present disclosure will be described via the following embodiments.

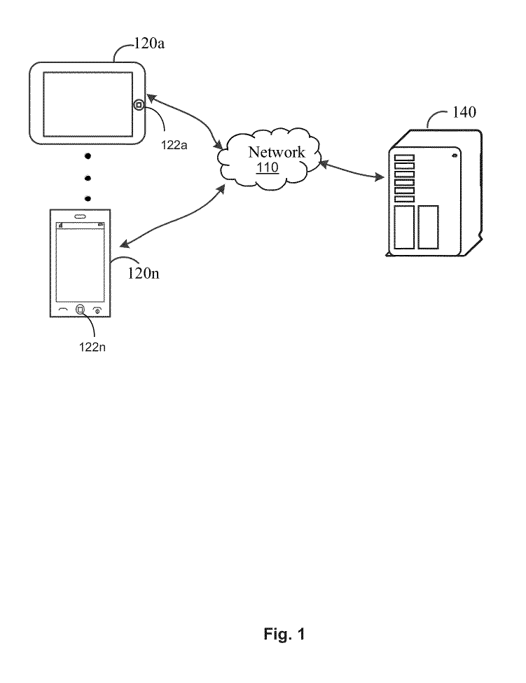

Referring to FIG. 1, which is an exemplary system diagram illustrating an environment of implementing an embodiment of the present disclosure schematic diagram of the environment of an embodiment of the present disclosure. The environment comprises one or more mobile terminals (120a to 120n) and a server (140).

The mobile terminal (120n) may be a smart mobile phone, a mobile computing tablet, a laptop computer, a desktop personal computer, a multi-media TV, a digital camera or an electronic reader, etc. Any devices which are capable of communicating with a network for web browsing, and equipped with a microphone input device (e.g., microphones 122a, 122n on respective mobile terminals 120a, 120n) may be suitable to carry out the invention.

The mobile terminal (120n) may be loaded with a payment application program (either downloaded as an application or transferred from another device, such as a flash memory drive, a laptop computer or another mobile terminal), which a user may operate the payment application program through a graphical user interface (GUI) on the mobile terminal (120n) to make payment on-line through a network connection (110) such as a wired network connection or a wireless network connection. To submit an on-line payment, the user may initially input information to the server (140) such as a user name as an account holder and a password for the account for payment validation.

Prior to performing the payment validation, the user may first undergo a payment validation registration with the server (140) in order to establish a speaker model as part of a user's profile for verification as being a legitimate user.

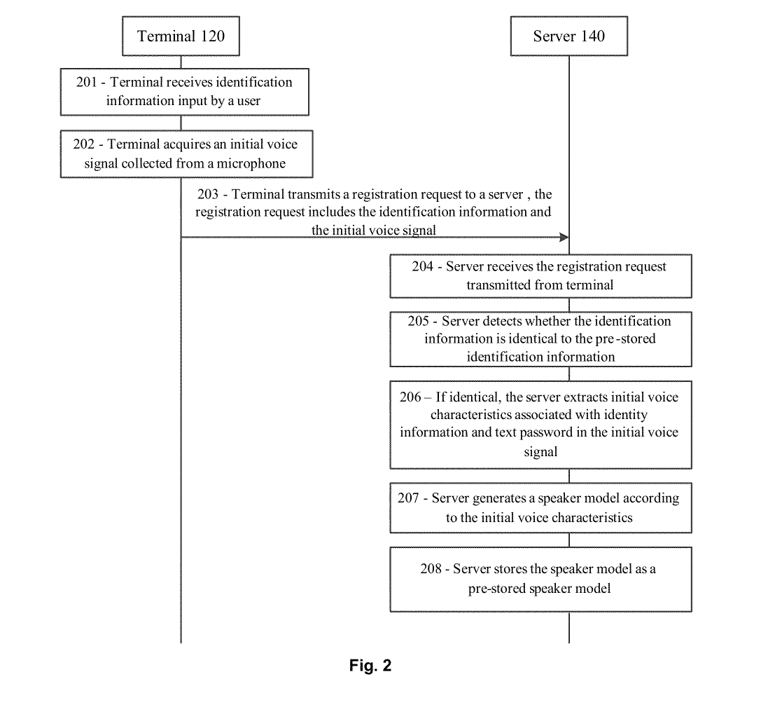

FIG. 2 is an exemplary process flow diagram illustrating a method for carrying out a payment validation request, according to an embodiment of the present disclosure. The method for payment validation may be carried out by the server (140) in the environment as shown in FIG. 1, which the server (140) stores speaker models of different users. The exemplary steps for payment validation may be illustrated as follows:

In step 201, the terminal (120) receives identification information input by a user. The user may input relevant identification information as prompted by a payment application program installed on the terminal (120). The identification information may include the user's payment account number, user's name and user's password corresponding to the account number. Such information may have been already been registered ahead of time with the server (140) (belong to a financial institution or to a merchant), prior to processing an on-line payment transaction.

In this embodiment, at the time of registering an account number for payment, the server may require the user to provide a voice signature sample for storage which may be used to authenticate the user's identity when a payment validation request is made by the user. Since the voice characteristics are unique to the user, therefore, user's voice characteristics may be stored in the server (140) as a signature of the user in a form of a speaker model or as a voiceprint model of a speaker. The speaker model in the server (140) is used to match against a current voice signal sample received later from the mobile terminal (120), at the time the user submits a payment validation request

The registration server here may be the same as or different from the payment server. If the registration server and the payment server are different, then the payment server must first pull the user's identification information from the registration server and take the identification information as the pre-stored identification information. The payment server here refers to the server (140) as shown in FIG. 1.

In step 202, the terminal (120) may acquire an initial voice signal collected from a microphone on the terminal (120). The microphone may be a built-in microphone (i.e., microphone (122n) in FIG. 1) or as an external input device attached to the terminal (120). When the user speaks into the microphone (120n) the user's voice is collected, converted by one or more processor known in the art (i.e., voice codec) as the initial voice signal, and transmitted through an interface over a network to the server (140).

In step 203, the terminal (120) may transmit a registration request to the server (140), the registration request may include the identification information input by the user (see step 201) and the initial voice signal spoken by the user and collected by a microphone on the terminal (120) (see step 202). Both of this information is required to execute a payment application program.

In step 204, the server (140) may receive the registration request (which include the identification information and the initial voice signal of the user) transmitted from the terminal (120).

In step 205, the server (140) may detect whether the identification information is identical to the pre-stored identification information. In the present embodiment, the server (140) may also communicate with a registration server (locally or remotely).

Under normal circumstances, the user may acquire identification information from the registration server when performing a registration operation (such as registering a payment account number and a password or merely registering a payment account number only) against a payment application program. The registration server may retain the identification information corresponding to both the payment account number and the password, and store the identification information as the pre-stored identification information. The registration server may thus perform payment validation accordingly.

It should be noted that the function of the registration server is invoked when the user performs a registration against a payment application program, and the function of the server (140) is invoked, when the user requests for a payment validation (i.e., the registration server and the server (140) may not be the same server). In this regard, the server (140) may compare if the user's identification information is identical to the pre-stored identification information from the registration server.

In step 206, the server (140) may extract initial voice characteristics associated with identity information and text password in the initial voice signal, after the server (140) confirms that the identification information is identical to the pre-stored identification information. Here the identify information is the information of the owner (i.e., the user) of the initial voice signal, which the characteristics of the initial voice signal is unique to the owner of the voice itself.

The text content of a password is the password as indicated or spoken in the initial voice signal (i.e., the text content recorded in the initial voice signal). For example, Zhang-San (i.e., name of a user) may speak into a microphone of the terminal (120) the following words “cun-nuan-hua-kai” as text content. The initial voice signal collected by the microphone not only includes a translated text content of the spoken words “cun-nuan-hua-kai” being the text password, but also includes the voice characteristics as displayed on a voice spectrum (i.e., frequency bands displayed in time-domain or a voice envelop) which is associated with the spoken words “cun-nuan-hua-kai”.

Such voice spectrum (i.e., frequency bands displayed in time-domain or a voice envelop) forms the characteristics of the initial voice signature (or voice fingerprint) which is unique to the voice of the speaker (i.e., Zhang-San) himself, at the time when the text password “cun-nuan-hua-kai” is spoken for establishing the initial voice signal for user's account registration. In other words, even with the same text password “cun-nuan-hua-kai” being spoken by another person (named as Li-shi), the voice characteristics as displayed on a voice spectrum (i.e., frequency bands displayed in time-domain or a voice envelop) would look differently, and therefore does not match the pre-stored voice characteristics of the initial voice signals of Zhang-San's.

The text content spoken in the initial voice signal may be in any language and may include one or more numeral, since not only the text content (i.e., the password) is being validated, but also the voice characteristics (i.e., frequency bands displayed in time-domain or a voice envelop) of the voice signals would be analyzed, when the text content is being spoken.

Some examples of the initial voice characteristics may be expressed in Mel frequency cepstral coefficients (MFCC) or linear predictive coding cepstral coefficients (LPCC). The Mel frequency cepstral coefficients (MFCC) or linear predictive coding cepstral coefficients (LPCC) may be associated with the identity information and the text password of the initial voice signal. Of course, other initial voice characteristics associated with the identity information and the text password of the initial voice signals may be acquired by other means which are known by a person of ordinary skill in the art.

In step 207, the server (140) may generate a speaker model according to the initial voice characteristics (i.e., frequency bands displayed in time-domain or a voice envelop). The server (140) may utilize the acquired initial voice characteristics for speaker model training to obtain a speaker model associated with the initial voice characteristics. Usually, the speaker model may be a Hidden Markov Model (HMM), a Gaussian Mixture Model (GMM) or a Support Vector Machine (SVM).

In an embodiment of the present disclosure, the speaker model may be established by utilizing a large amount of voice data to adaptively train a universal background model (UBM) to obtain an adaptive user's speaker model based on the Gaussian Mixture Model (GMM). The speaker model can be adaptively trained using a speech of the speaker himself or herself on a universal background model (UBM). Such adaptive training is statistically performed through repeated speaking of the text password by the speaker. The UBM may also be trained by a large amount of speech data spoken by a large sample of speakers.

In step 208, the server (140) may store the results of the adaptively trained voice signature (or voice fingerprint) model as a pre-stored speaker model into the register server (or alternatively, in server (140)). It may be noted that the terminal (120) may carry out steps 201 through 203, while the server (140) may carry out steps 204 through 208 in the payment validation method.

To summarize, FIG. 2 illustrates the steps taken to establish the pre-stored identification information (i.e., the user account information, user identity, text password etc.) and the pre-stored initial voice print model (which is a voice signature) of the user prior to the user initiating a current payment validation request to process a payment transaction. The illustrated payment validation method may include acquiring an initial voice characteristics according to an initial voice signal, and constructing a speaker model associated to the identify information and the text password of the initial voice signal according to the initial voice characteristics, such that when payment validation for a new transaction becomes necessary, the user only needs to speak the identifying information (i.e., the text password) and matches his voice characteristics to the voice characteristics according to the pre-stored speaker model prior to authorizing a payment transaction.

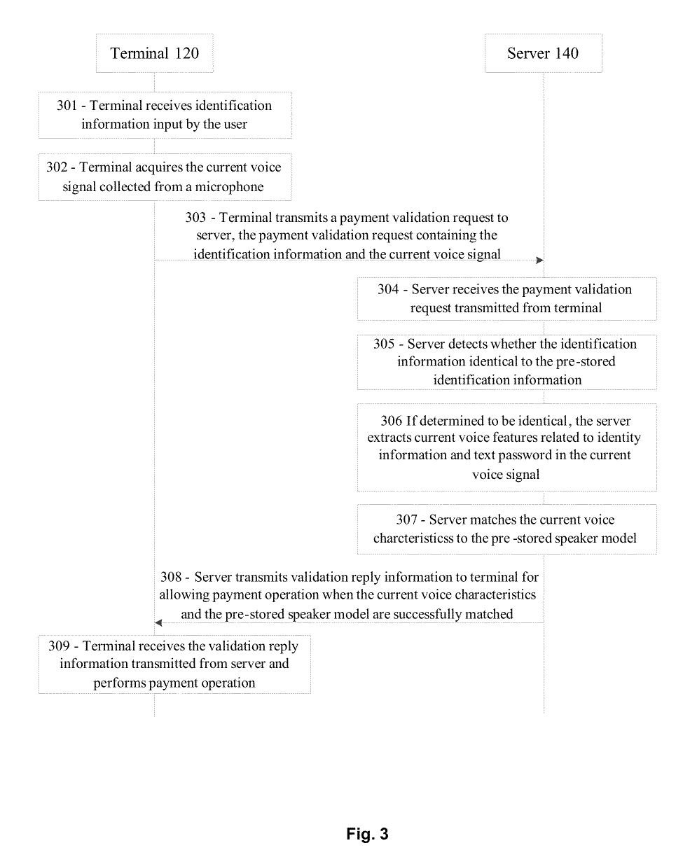

FIG. 3 is an exemplary process flow diagram illustrating a method for carrying out a payment validation request, according to another embodiment of the present disclosure. More specifically, FIG. 3 illustrates the current payment validation request operations that take place between the terminal (120) and the server (140), after establishing the pre-stored identification information (i.e., the user account information, user identity, text password etc.) and the pre-stored initial voice signature of the user as illustrated in FIG. 2. The method for payment validation may include:

In step 301, the terminal (120) may receive identification information input by a user. The user may input relevant identification information as prompted by a payment application program installed on the terminal (120). The identification information may include the user's payment account number, user's name and user's password corresponding to the account number. Such information may have been already been registered ahead of time with the server (140) (belong to a financial institution or to a merchant), prior to processing an on-line payment transaction.

The registration server here may be the same as or different from the payment server (140). If the registration server and the payment server are different, then the payment server must first pull the user's identification information from the registration server and take the identification information as the pre-stored identification information. The payment server here refers to the server (140) as shown in FIG. 1.

In step 302, the terminal (120) may acquire current voice signal collected from a microphone on the terminal (120). The microphone may be a built-in microphone (i.e., microphone (122n) in FIG. 1) or as an external input device attached to the terminal (120). When the user speaks into the microphone (120n) the user's voice is collected, converted by one or more processor known in the art (i.e., voice codec) as the initial voice signal, and transmitted through an interface over a network to the server (140).

In step 303, the terminal (120) may transmit a current payment validation request to the server (140), the current payment validation request may include the identification information input by the user (see step 201) and the current voice signal spoken by the user and collected by a microphone on the terminal (120) (see step 202). Both of this information is required to execute a payment application program.

In step 304, the server (140) may receive the current payment validation request (which include the identification information and the current voice signal of the user) transmitted from the terminal (120).

In step 305, the server (140) may detect whether the identification information is identical to the pre-stored identification information acquired from a registration server (not shown). If not identical, the identification information is not registered with the server (140), and the payment validation request operation fails.

In step 306, the server (140) extracts current voice characteristics associated with the identity information and a text password in the current voice signal, when server (140) detects that the identification information is identical to the pre-stored identification information. The identify information refers to the information pertaining to the owner of the current voice signal, whose voice characteristics (i.e., frequency bands displayed in time-domain or a voice envelop) is unique to the user, and thus represents an identity of the owner of the current voice signal or voice producer.

When the acquired identification information in the payment validation request is identical to the pre-stored identification information, the server (140) may extract the current voice characteristics in the current voice signal associated with the identity information and the text password in the current voice signal.

Here the text password may be the password spoken of in the current voice signal. For example, the current voice signal spoken into the microphone of the terminal 120 by the user Zhang-San may be “325 zhi-fu”, then Zhang-San may be the owner of the current voice signal, and “325 zhi-fu” is the text password of the current voice signal. Of course, the content of the text password may include numeral, text or note in any language.

In general, the current voice characteristics may be expressed in the Mel frequency cepstral coefficients (MFCC) or the linear predictive coding cepstral coefficients (LPCC). The Mel frequency cepstral coefficients (MFCC) or the linear predictive coding cepstral coefficients (LPCC) may be associated with the identity information and the text password of the current voice signal. Of course, other current voice characteristics associated with the identity information and the text password of the current voice signals may be acquired by other means which are known by a person of ordinary skill in the art.

In step 307, the server (140) may match the current voice characteristics (i.e., frequency bands displayed in time-domain or a voice envelop) to the pre-stored speaker model. The pre-stored speaker model may be a Hidden Markov Model (HMM), Gaussian Mixture Model (GMM) or Support Vector Machine (SVM).

Matching the current voice characteristics to the pre-stored speaker model may include: computing a likelihood score using the speech features such as MFCC or LPCC on both the pre-stored speaker model and the universal background model (UBM); getting the log-likelihood ratio score using the two likelihood score; and deciding that the current voice characteristics and the pre-stored speaker model (or voiceprint model) are successfully matched, if the likelihood ratio score has exceeded a predetermined threshold.

For example, extracting the speech features of the current voice signal, and using the features to compute the likelihood score on the pre-stored speaker model and the universal background model (UBM). Here the likelihood score may be expressed as a log-likelihood ratio score, i.e. the difference between the log-likelihood value of the voice signature model and the log-likelihood value of the universal background model (UBM):

$$score = \frac{1}{T} ( log p ( X \vert {λ}_{spk} ) - log p ( X \vert {λ}_{ubm} ) )$$

In the above formula, X is the current voice feature detected, T is the frame number of the voice feature, λₛₚₖ is the speaker model of the target speaker, and λ_{ubm} is the universal background model (UBM).

Normally, a high log-likelihood ratio score may be obtained only when the speaker and the text password spoken are determined to be fully identical to the speaker and the text password at the time of user registration, otherwise, successful matching is considered to have been achieved as long as the log-likelihood ratio score has exceeded a predetermined threshold.

On the other hand, if it is determined that the current voice signal of the speaker and the text password is not identical to the speaker and the text password at the time of user registration (i.e., may be due to a sore throat or a mouth injury), the log-likelihood ratio score would usually be lower, to an extent that the log-likelihood ratio score would be so low that it is below a predetermined threshold. When this happens, there would not be a successful match determined.

In an embodiment, it may be determined that a successful match may be found when the current voice features and pre-stored speaker model has reached a log-likelihood ratio of higher than a predetermined threshold (say >60%). In actual application, the higher the predetermined threshold is set, the higher the degree of security level is reached for a successful matching.

However, since the acquired current voice signal may be subjected to external environmental interference, the current voice signal acquired each time may be slightly different. Hence the predetermined threshold may be set based on an actual environment. The specific value of the predetermined threshold is not limited by this embodiment.

In step 308, the server (140) may transmit validation reply information to the terminal (120) for allowing payment transaction operation, if the current voice characteristics and the pre-stored speaker model have been successfully matched.

If the current voice characteristics is successfully matched to the pre-stored speaker model, then the server (140) may indicate in the validation reply information that the current speaker and the text password spoken are the same as the speaker and the text password pre-stored at the time of user registration, the server (140) may proceed to allow the user to perform a subsequent payment operation.

In step 309, the terminal (120) may receive the validation reply information transmitted from the server (140) and may proceed to perform a payment transaction. More specifically, the terminal (120) may receive the validation reply information transmitted from server (140) to authorize the terminal (120) to proceed to perform a transaction operation.

It must be noted that steps 301 through 303 and step 309 may be performed by the terminal (120) in the payment validation method, and steps 304 through 308 may be performed by the server (140) in the payment validation method.

To summarize, FIG. 3 illustrates a payment validation method with the following benefits: by receiving a payment validation request transmitted from a terminal (120), the current voice characteristics associated to the identity information and the text password in the current voice signal. If it is detected that the identification information in the payment validation request is identical to or the same as the pre-stored identification information, the server (140) may transmit a validation reply information to the terminal (120) to authorize for payment transaction, after successfully matching the current voice characteristics and the pre-stored speaker model.

The illustrated method replaces the step of generation of SMS validation messages by the server (140) by matching of the current voice signal to the pre-stored speaker model. In effect, the illustrated payment validation method has at least eliminated the extra steps in the prior art method, which requires separately generating a SMS by the server (140) to send to the terminal (120) to be entered by the user for further security verification. Thus the current invention has reduced the operating cost by simplifying the payment validation process using the unique identity of the user (i.e., the voice signature) during the validating process. In addition, the user experience is enhanced with reduced operations as required by the user.

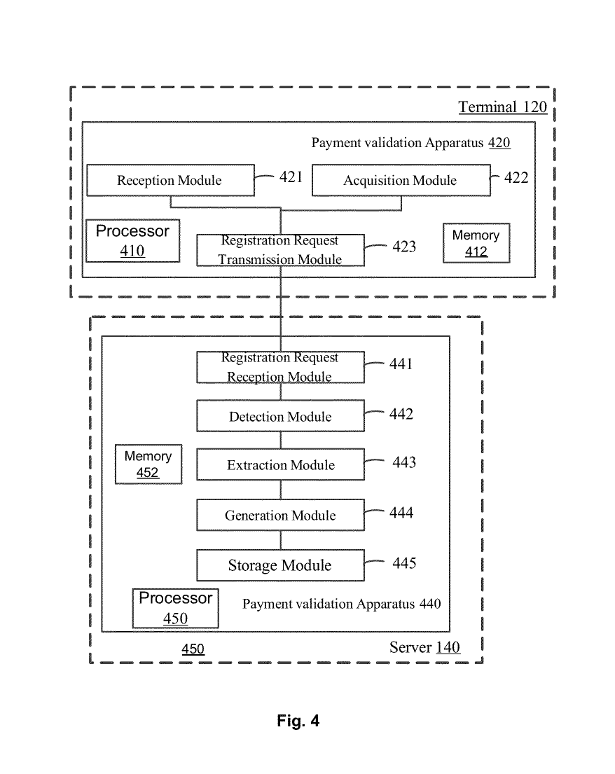

FIG. 4 is an exemplary system block diagram illustrating a system for carrying out a payment validation according to an embodiment of the present disclosure. Prior to performing a payment validation, a user must first register through the terminal (120) with the server (140) for payment validation registration, which registration requires establishing a pre-stored speaker model in the server (140) or alternately, in a registration server (not shown).

The system for payment validation may include at least a terminal (120) and a server (140). The terminal (120) may include a payment validation apparatus (420), and the server (140) may include a payment validation apparatus (440).

The payment validation apparatus (420) on the terminal (120) may include at least a processor (410), working in conjunction with a memory (412) and a plurality of modules, the modules include at least a reception module (421), a acquisition module (422) and a registration request transmission module (423).

The reception module (421) is for receiving identification information input by the user. The acquisition module (422) is for acquiring an initial voice signal collected from a built-in microphone of the terminal (120). The registration request transmission module (423) is for transmitting a registration request to the server (140); the registration request may include identification information received by the reception module (421) and an initial voice signal acquired by the second acquisition module (422).

The payment validation apparatus (440) on the server (140) may include at least a processor (450), working in conjunction with a memory (452) and a plurality of modules, the modules include at least a registration request reception module (441), a detection module (442), an extraction module (443), a generation module (444) and a storage module (445).

The registration request reception module (441) is for receiving a registration request transmitted from the terminal (120); the registration request may include the identification information and the initial voice signal of the user.

In other words, the registration request reception module (441) is for receiving a registration request transmitted from the registration request transmission module (423) in the terminal (120).

The second detection module (442) is for detecting whether the identification information in the registration request received by the registration request reception module (441) is identical to or the same as the pre-stored identification information.

The second extraction module (443) is for extracting initial voice characteristics associated with the identity information and the text password in the initial voice signal when the identification information detected by the detection module (442) is the identical to or the same as the pre-stored identification information; wherein the identify information is the information of the owner of the initial voice signal, the text password is the password indicated by the initial voice signal. The initial voice characteristics may include Mel frequency cepstral coefficients (MFCC) or linear predictive coding cepstral coefficients (LPCC) of the initial voice signal.

The generation module (444) is for generating a speaker model according to the initial voice characteristics extracted by the extraction module (443); wherein the speaker model may include at least one of: a Hidden Markov Model (HMM), Gaussian Mixture Model (GMM) or Support Vector Machine (SVM).

The storage module (445) is for storing the speaker model generated by the generation module (444) and storing the speaker model as a pre-stored speaker model.

Summarizing the above, the payment validation system provided by the above embodiment of the present disclosure acquires an initial voice signal and acquires initial voice characteristics according to the initial voice signal, and builds a speaker model related to the identify information and the text password of the initial voice signal according to the initial voice characteristics, such that when payment validation is needed, the user is required only to match besides the identity information such as a text password, also to the initial voice characteristics of the initial voice signal to the speaker model to determine whether or not to perform payment transaction operation.

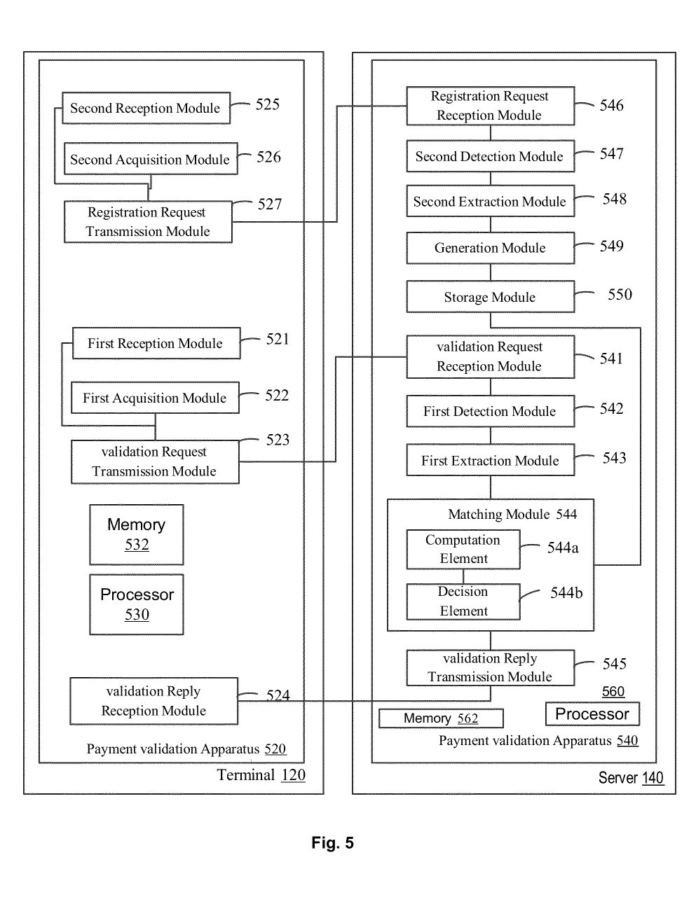

FIG. 5 is an exemplary system block diagram illustrating a system for carrying out a payment validation according to another embodiment of the present disclosure. Referring to FIG. 5, the system for payment validation may include at least a terminal (120) and a server (140). The terminal (120) may include a payment validation apparatus (520), and the server (140) may include a payment validation apparatus (540).

The payment validation apparatus (520) in the terminal (120) may include at least a processor (530) working in conjunction with a memory (532) and a plurality of modules, the plurality of modules may include at least a first reception module (521), a first acquisition module (522), a validation request transmission module (523) and a validation reply reception module (524).

The first reception module (521) is for receiving identification information input by the user. The first acquisition module (522) is for acquiring current voice signal collected from a microphone of the terminal (120). The validation request transmission module (523) is for transmitting a payment validation request to the server (140). The payment validation request may include the identification information received by the first reception module (521) and the current voice signal acquired by the first acquisition module (522). The validation reply reception module (524) is for receiving the validation reply information or message transmitted from the server (140) in order to perform a payment transaction.

The payment validation apparatus (540) in the server (140) may include at least a processor (560) working in conjunction with a memory (562) and a plurality of modules, the plurality of modules may include at least a validation request reception module (541), a first detection module (542), a first extraction module (543), a matching module (544) and a validation reply transmission module (545).

The validation request reception module (541) is for receiving a payment validation request transmitted from the validation request transmission module (523) of terminal (120); the payment validation request may include identification information and the current voice signal.

The first detection module (542) detects whether the identification information in the payment validation request received by the validation request reception module (541) is identical to or the same as the pre-stored identification information. The first extraction module (543) is for extracting the current voice characteristics associated with the identity information and the text password in the current voice signal, when it is detected that the identification information detected by the first detection module (542) is identical to or the same as the pre-stored identification information, which the current voice characteristics may include Mel frequency cepstral coefficients (MFCC) or linear predictive coding cepstral coefficients (LPCC) of the current voice signal.

The matching module (544) is for matching the current voice characteristics extracted by the first extraction module (543) to the speaker model pre-stored by the storage module (550), wherein the speaker model may include at least one of: a Hidden Markov Model (HMM), Gaussian Mixture Model (GMM) or Support Vector Machine (SVM).

The computation element (544a) is for computing a likelihood score of the current voice characteristics extracted by the first extraction module (543) and from the pre-stored speaker model. The decision element (544b) is for determining whether the current voice characteristics has successfully been matched to the pre-stored speaker model, which the likelihood score computed by the computation element (544a) would exceed a predetermined threshold. In an embodiment, the likelihood score is a log-likelihood ratio score.

The validation reply transmission module (545) is for transmitting a validation reply message or information to the terminal (120) to indicate that a payment transaction has been authorized, after the current voice characteristics have been successfully matched to the pre-stored speaker model.

In another embodiment of the payment validation system, the payment validation apparatus (520) of terminal (120) may further include: a second reception module (525), a second acquisition module (526) and a registration request transmission module (527).

The second reception module (525) is for receiving identification information input by the user. The second acquisition module (526) is for acquiring an initial voice signal collected from the microphone of the terminal (120). The registration request transmission module (527) is for transmitting a registration request to the server (140), where the registration request may include the identification information received by the second reception module (525) and the initial voice signal acquired by the second acquisition module (526).

Likewise, in another embodiment of the payment validation system, the payment validation apparatus (540) of the server (140) may further include: a registration request reception module (546), a second detection module (547), a second extraction module (548), a generation module (549) and a storage module (550).

The registration request reception module (546) is for receiving a registration request transmitted from the registration request transmission module (527) of the terminal (120). The second detection module (547) is for detecting whether the identification information in the registration request is identical to or the same as the pre-stored identification information. The second extraction module (548) is for extracting initial voice characteristics related to the identity information and the text password in the initial voice signal, after it is detected that the identification information is identical to or being the same as the pre-stored identification information. As previously discussed, the identify information is the information of the owner of the initial voice signal, and the text password is the same password indicated by the owner's initial voice signal. The initial voice characteristics may include Mel frequency cepstral coefficients (MFCC) or linear predictive coding cepstral coefficients (LPCC) of the initial voice signal.

The generation module (549) is for generating a speaker model according to the initial voice characteristics extracted by the second extraction module (548). As previously discussed, the speaker model is at least one of: a Hidden Markov Model (HMM), Gaussian Mixture Model (GMM) or Support Vector Machine (SVM). The storage module (550) is for storing the speaker model, which is generated by the generation module (549) with the stored speaker model as the pre-stored speaker model of the owner.

Summarizing the above, the payment validation system of the present disclosure provides the following benefits: matching the current voice characteristics related to the identity information and the text password in the owner's current voice signal server (140) to the pre-stored identification information and the pre-stored speaker model have accomplished the payment validation objectives. The present disclosure resolves the problems associated with prior art payment operation processes in which the server (140) is required to send SMS validation messages which causes an increase in operating cost. Therefore, the present disclosure is capable of significantly enhancing payment safety and enormously reducing operating cost incurred by SMS validation messages merely by means of voice signature identification of the owner's voice signal.

It should be noted that while the payment validation apparatus provided by the foregoing embodiment is illustrated in connection with the division of the various functional modules, in actual application the aforesaid functions may be completed by different functional modules depending on the needs, i.e. the internal structures of the terminal and the server are divided into different functional modules to complete all or some of the functions. In addition, the payment validation apparatus in the payment validation system provided by the foregoing embodiment and the embodiments of the payment validation method have the same concept, and their implementations are shown in the embodiments of the payment validation method. The arrangement of the foregoing embodiments is merely intended to facilitate illustration of the present disclosure and does not signify the quality of the embodiments.

It should be understood by those with ordinary skill in the art that all or some of the steps of the foregoing embodiments may be implemented by hardware, or software program codes stored on a non-transitory computer-readable storage medium with computer-executable commands stored within. For example, the invention may be implemented as an algorithm as codes stored in a program module or a system with multi-program-modules. The computer-readable storage medium may be, for example, nonvolatile memory such as compact disc, hard drive or flash memory. The said computer-executable commands are used to enable a computer or similar computing device to accomplish the payment validation request operations.

The foregoing represents only some preferred embodiments of the present disclosure and their disclosure cannot be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent changes and modifications of the foregoing embodiments are to be viewed as being within the scope of the technical solution of the present disclosure.

What is claimed is:

1. A method for payment validation, comprising performing by a server:
receiving a payment validation request from a terminal, wherein the payment validation request comprises identification information and a current voice signal;
detecting whether the identification information is identical to a pre-stored identification information; if identical:
extracting voice characteristics associated with an identity information and a text password from the current voice signal;
matching the current voice characteristics to a pre-stored speaker model; if successfully matched:
sending an validation reply message to the terminal to indicate that payment request has been authorized, wherein the validation reply message is utilized by the terminal to proceed with a payment transaction, wherein the identity information identifies an owner of the current voice signal, and the text password is a password indicated by the current voice signal.

2. The method according to claim 1, wherein prior to receiving the payment validation request from the terminal, the method comprising:
receiving a registration request sent from the terminal, wherein the registration request comprises the identification information and an initial voice signal;
detecting whether the identification information is identical to the pre-stored identification information; if identical:
extracting initial voice characteristics associated with the identity information and the text password from the initial voice signal;
generating a speaker model according to the initial voice characteristics;
storing the speaker model and taking the stored speaker model as the pre-stored speaker model,
wherein the identity information identifies an owner of the initial voice signal, and the text password is a password indicated by the initial voice signal.

3. The method according to claim 2, wherein the step of matching the current voice characteristics to the pre-stored speaker model, comprising:
computing a likelihood score of the matching of the current voice characteristics to the pre-stored speaker model; and
deciding that the current voice characteristics and the pre-stored speaker model are successfully matched, if the likelihood score has exceeded a predetermined threshold.

4. The method according to claim 3, wherein:
the current voice characteristics comprises Mel frequency cepstral coefficients (MFCC) or linear predictive coding cepstral coefficients (LPCC) of the current voice signal,
the initial voice characteristics comprises the Mel frequency cepstral coefficients (MFCC) or the linear predictive coding cepstral coefficients (LPCC) of the initial voice signal,
the speaker model comprises at least one of: a Hidden Markov Model (HMM), Gaussian Mixture Model (GMM) or Support Vector Machine (SVM), and
the likelihood score comprises a log-likelihood ratio score.

5. A method for processing a payment validation request sent through a microphone of a terminal, comprising a server, performing:
receiving from the terminal, identification information input by a user;
acquiring current voice signal collected by the terminal microphone;
transmitting a payment validation request from the terminal to the server, wherein the payment validation request comprises identification information and the current voice signal, such that the server performs validation on the payment validation request;
detecting whether the identification information is identical to a pre-stored identification information; if identical:
extracting voice characteristics associated with an identity information and a text password from the current voice signal;
matching the current voice characteristics to a pre-stored speaker model; if successfully matched:
sending by the server, an validation reply message to the terminal to indicate that payment request has been authorized, wherein the validation reply message is utilized by the terminal to proceed with a payment transaction, wherein the identity information identifies an owner of the current voice signal, and the text password is a password indicated by the current voice signal.

6. The method according to claim 5, further comprising the following steps prior to receiving identification information input by the user:
receiving identification information input by the user;
acquiring by the server, an initial voice signal collected by the terminal microphone;
sending a registration request from the terminal to the server, wherein the registration request comprises the identification information and the initial voice signal;
detecting by the server, whether the identification information is identical to the pre-stored identification information; if identical:
extracting initial voice characteristics associated with the identity information and the text password from the initial voice signal;
generating a speaker model according to the initial voice characteristics;
storing the speaker model and taking the stored speaker model as the pre-stored speaker model.

7. An apparatus for payment processing a payment validation request on a server, comprises at least a processor operating in conjunction with a memory and a plurality of modules, the plurality of modules comprise:
an validation request reception module for receiving a payment validation request sent from a terminal, the payment validation request comprises identification information and a current voice signal;
a first detection module for detecting whether the identification information is identical to a pre-stored identification information;
a first extraction module for extracting voice characteristics associated with an identity information and a text password from the current voice signal; when it is detected that the identification information is identical to the pre-stored identification information;
a matching module for matching the current voice characteristics to a pre-stored speaker model; if successfully matched;
an validation reply transmission module for transmitting an validation reply message to the terminal to indicate that payment request has been authorized for payment transaction, when it is determined that the current voice characteristics has been successfully matched to a pre-stored speaker model, such that the terminal utilizes the received validation reply message to proceed with a payment transaction,
wherein the identity information identifies an owner of the current voice signal, and the text password is a password indicated by the current voice signal.

8. The apparatus according to claim 7, further comprises:
a registration request reception module for receiving a registration request sent from the terminal, the registration request comprises the identification information and an initial voice signal;
a second detection module for detecting whether the identification information in the registration request received by the registration request reception module is the same as the pre-stored identification information;
a second extraction module for extracting the initial voice characteristics associated with the identity information and the text password from the initial voice signal; when it is determined that the identification information detected by the second detection module is identical to the pre-stored identification information;
a generation module for generating a speaker model according to the initial voice features extracted by the second extraction module;
a storage module for storing the speaker model generated by the generation module, and taking the stored speaker model as a pre-stored voice print model,
wherein the identify information is the information of the owner of the initial voice signal, and the text password is the password indicated by the initial voice signal.

9. The apparatus according to claim 8, wherein the matching module comprises:
a computation element for computing a likelihood score of the matching of the current voice characteristics to the pre-stored speaker model;
a decision element for deciding that the current voice characteristics and the pre-stored speaker model are successfully matched, if the likelihood score has exceeded a predetermined threshold.

10. The apparatus according to claim 9, wherein:
the current voice characteristics comprises Mel frequency cepstral coefficients (MFCC) or linear predictive coding cepstral coefficients (LPCC) of the current voice signal,
the initial voice characteristics comprises the Mel frequency cepstral coefficients (MFCC) or the linear predictive coding cepstral coefficients (LPCC) of the initial voice signal,
the speaker model comprises at least one of: a Hidden Markov Model (HMM), Gaussian Mixture Model (GMM) or Support Vector Machine (SVM), and
the likelihood score comprises a log-likelihood ratio score.

11. An apparatus for processing payment validation request within a terminal utilizing a microphone, comprises at least a processor operating in conjunction with a memory and a plurality of modules, the plurality of modules comprise:
a first reception module for receiving identification information input by a user;
a first acquisition module for acquiring current voice signal collected from the microphone;
a validation request transmission module for transmitting a payment validation request to a server, the payment validation request containing the identification information received by the first reception module and the current voice signal acquired by the first acquisition module, such that the server receiving the payment validation request from the terminal performs:
detecting whether the identification information is identical to the pre-stored identification information; if it is detected to be identical:
extracting voice characteristics associated with an identity information and a text password from the current voice signal;
matching the current voice characteristics to a pre-stored speaker model;
if successfully matched:
an validation reply transmission module for transmitting an validation reply message to the terminal to indicate that payment request has been authorized for payment transaction, such that the terminal;
an validation reply reception module in the apparatus for receiving the validation reply message transmitted from the server, and utilizing the received validation reply message to proceed with a payment transaction.

12. The apparatus as defined in claim 11, further comprises:
a second reception module for receiving identification information input by the user;
a second acquisition module for acquiring an initial voice signal collected from the microphone;
a registration request transmission module for transmitting a registration request to the server, the registration request comprises the identification information and the initial voice signal, such that the server receiving the registration request from the terminal, performing:
detecting whether the identification information is identical to the pre-stored identification information, if identical:
extracting initial voice characteristics associated with the identity information and the text password from the initial voice signal;
generating a speaker model according to the initial voice characteristics;
storing the speaker model and taking the stored speaker model as the pre-stored speaker model, wherein the identity information identifies an owner of the initial voice signal, and the text password is a password indicated by the initial voice signal.

13. A system for payment validation, comprises at least a terminal and a server, the terminal and the server being connected through a wired network connection or a wireless network connection,
wherein the terminal utilizes a microphone, comprises at least a processor operating in conjunction with a memory and a plurality of modules, the plurality of modules comprise:
a first reception module for receiving identification information input by a user;
a first acquisition module for acquiring current voice signal collected from the microphone;
a validation request transmission module for transmitting a payment validation request to the server, the payment validation request containing the identification information received by the first reception module and the current voice signal acquired by the first acquisition module, such that the server receiving the payment validation request from the terminal performs:
detecting whether the identification information is identical to the pre-stored identification information; if it is detected to be identical:
extracting voice characteristics associated with an identity information and a text password from the current voice signal;
matching the current voice characteristics to a pre-stored speaker model;
if successfully matched:
an validation reply transmission module for transmitting an validation reply message to the terminal to indicate that payment request has been authorized for payment transaction, such that the terminal;
an validation reply reception module in the apparatus for receiving the validation reply message transmitted from the server, and utilizing the received validation reply message to proceed with a payment transaction;
wherein the server comprises:
at least a processor operating in conjunction with a memory and a plurality of modules, the plurality of modules comprise:
an validation request reception module for receiving a payment validation request sent from a terminal, the payment validation request comprises identification information and a current voice signal;
a first detection module for detecting whether the identification information is identical to a pre-stored identification information;
a first extraction module for extracting voice characteristics associated with an identity information and a text password from the current voice signal; when it is detected that the identification information is identical to the pre-stored identification information;
a matching module for matching the current voice characteristics to a pre-stored speaker model; if successfully matched;
an validation reply transmission module for transmitting an validation reply message to the terminal to indicate that payment request has been authorized for payment transaction, when it is determined that the current voice characteristics has been successfully matched to a pre-stored speaker model, such that the terminal utilizes the received validation reply message to proceed with a payment transaction,
wherein the identity information identifies an owner of the current voice signal, and the text password is a password indicated by the current voice signal.
